(19) United States
(12) Patent Application Publication
(10) Pub. No.: US 2004/0156524 A1
(43) Pub. Date: Aug. 12, 2004

(54) Component member for electric, component member for electro-acoustic transducers, and method of manufacturing the same

(76) Inventors: Kazuro Okuzawa, Mie (JP); Shoji Nakajima, Mie (JP)

Correspondence Address: WENDEROTH, LIND & PONACK, L.L.P., 2033 K STREET N. W., SUITE 800, WASHINGTON, DC, 20006-1021, US

(21) Appl. No.: 10/451,688

(22) PCT Filed: May 21, 2002
(86) PCT No.: PCT/JP02/04915

(51) Int. Cl. H04R 25/00; H04R 11/02

(52) U.S. Cl. 381/396; 29/594; 29/607; 381/191

(57) ABSTRACT

The present invention relates to a member for electric equipment, having a surface treatment layer mainly consisting of colloidal silica formed on a surface of a metallic component with a zinc or zinc alloy layer formed thereon, and a protective layer formed on a surface of the surface treatment layer. Further, the surface treatment layer includes at least one of aluminum, titanium, and cobalt as a metallic component. According to a configuration of the present invention, it is possible to provide a metallic member for the electric equipment and a member for an electro-acoustic transducer that has excellent heat resistance, corrosion resistance, and bonding strength.

### TECHNICAL FIELD

The present invention relates to a surface treatment method of iron-based members having excellent corrosion resistance which can be used for various electric equipment, and surface-treated members, and a method of manufacturing them. Particularly, the present invention is applicable for members used in electro-acoustic transducers for acoustic equipment, and for a production of the electro-acoustic transducers.

### BACKGROUND ART

As an example of various electric and electronic equipment, a loudspeaker that is a kind of conventional electro-acoustic transducer will be described in the following with reference to a sectional view shown in FIG. 4.

The loudspeaker shown in FIG. 4 comprises magnetic circuit 1 comprising upper plate 1a, magnet 1b, and lower plate 1c with a center pole; frame 2 bonded to the magnetic circuit 1; diaphragm 3 connected to voice coil 4 with its outer periphery connected to the frame 2 via an edge portion and its inner periphery inserted in magnetic gap 1d of the magnetic circuit 1; and damper 5 with its outer periphery connected to the frame 2 and its inner periphery connected to the voice coil 4.

The upper plate 1a, lower plate 1c, and frame 2 bonded to the magnetic circuit 1, which form the magnetic circuit 1 of the loudspeaker having a configuration as described above, are made of iron-based metallic materials. Generally, the frame 2, upper plate 1a, and lower plate 1c are zinc plated for the purpose of rust prevention (corrosion prevention), which is further chromate-treated in order to enhance the rust prevention (corrosion prevention) effect.

Recently, as an electric equipment is increasingly reduced in size and requested to have high performance, there are requests for miniaturization and high output level in the field of loudspeakers, and components used in loudspeakers are also required to have heat resistance. On the other hand, in the corrosion prevention technology for conventional iron-based members zinc plated and chromate-treated, there is a possibility of such problems that the surface of metal is not uniform and that the adhesion by an adhesive is not enough. It is probably because the adhesion of chromate layer itself on the surface is defective and, also, the adhesion varies due to a variation in thickness of the chromate layer. There is also a problem that the chromate layer itself is poor in heat resistance. For example, when the chromate layer is exposed to an atmosphere of 100° C. for a long period of time, there is a possibility of cracking in the zinc plated surface and affecting the corrosion resistance.

Recently, a rust prevention solution and a treating method for metallic members are proposed, wherein a treating solution containing colloidal silica, Ti compound, and Co compound is used for the treatment. It is known that the metallic members having corrosion resistance equivalent to that obtained by chromate treatment can be obtained by the above treating method.

The inventor of the present invention have found, as a result of some-experiments, that the bonding strength and heat resistance as well as the corrosion resistance of the members may be improved by performing the surface treatment on component members of electro-acoustic transducers, and that highly reliable electro-acoustic transducers can be manufactured.

In order to address the conventional problems, purposes of the present invention are to provide members for electric and electronic equipment and members for electro-acoustic transducers which are excellent in heat resistance and have excellent bonding strength, and to provide a method of manufacturing them.

### DISCLOSURE OF THE INVENTION

The present invention relates to a component member for electric equipment having a surface treatment layer comprising colloidal silica formed on a surface of a metallic component with a zinc or zinc alloy layer formed on a surface thereof, and a protective layer formed on a surface of the surface treatment layer. Further, the surface treatment layer includes at least one of aluminum, titanium, and cobalt as a metallic component. According to the above configuration, it is possible to provide metallic members for electric equipment and for electro-acoustic transducers, that have excellent heat resistance, excellent corrosion resistance and excellent bonding strength, and to provide their manufacturing method.

### BRIEF DESCRIPTION OF THE DRAWINGS

FIG. 1 is a sectional view of an upper plate, an essential part of a loudspeaker in one embodiment of the present invention.

FIG. 2 is a process flow chart showing a surface treatment process in the present invention.

FIG. 3 is a graph showing a comparison between the present preferred embodiment and a conventional product with respect to a bonding strength between an upper plate and magnet of a loudspeaker.

FIG. 4 is a graph showing a comparison between the present invention and a conventional product with respect to heat resistance.

FIG. 5 is a sectional view showing the configuration of a conventional loudspeaker.

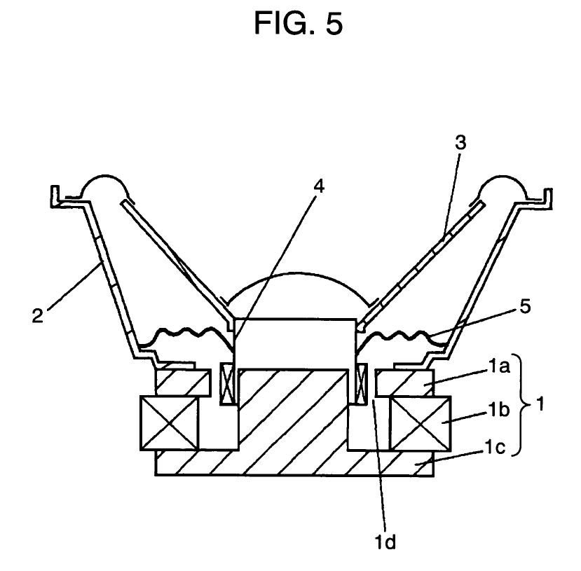

### DESCRIPTION OF THE PREFERRED EMBODIMENTS

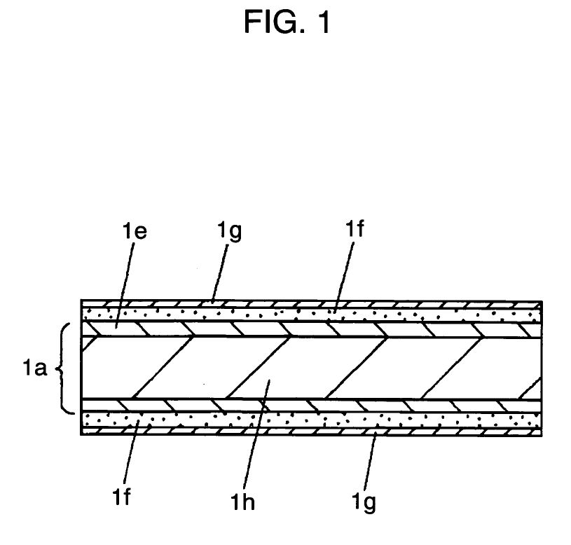

A preferred embodiment of the present invention will be described in the following with reference to FIG. 1 to FIG. 4 using a loudspeaker, that is one of acoustic transducers, as an example. In FIG. 1 to FIG. 4, same components as in the prior art are given same reference numerals, and the description is omitted.

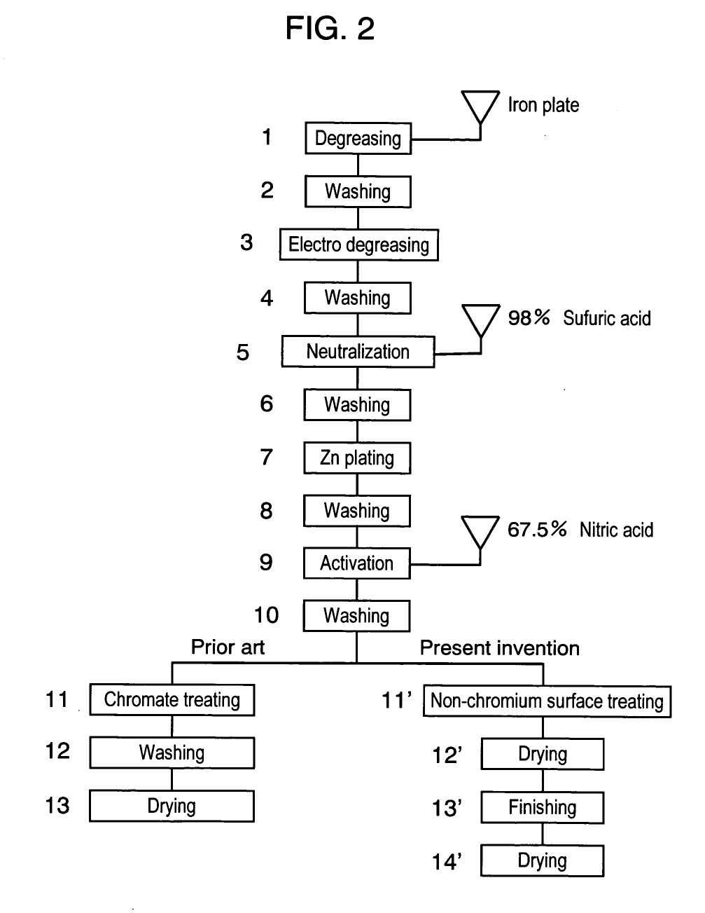

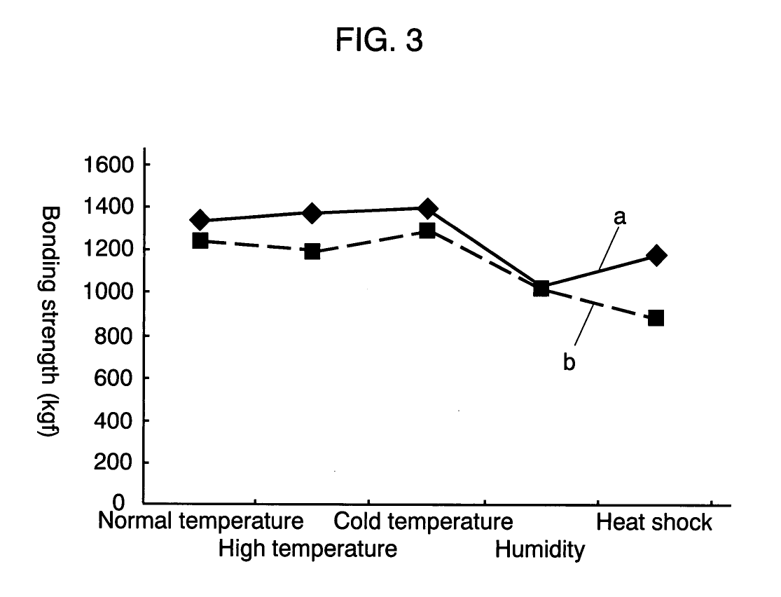

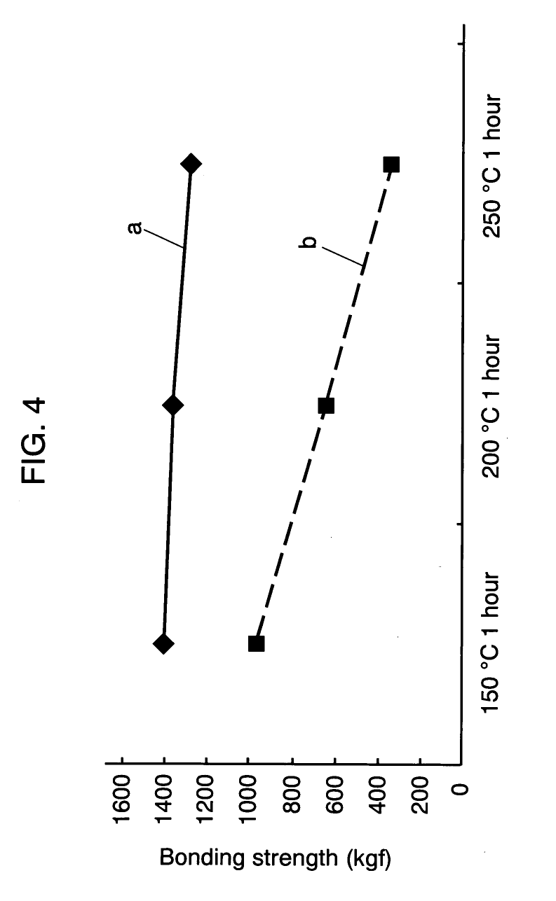

FIG. 1 is a sectional view of an upper plate in one preferred embodiment of the present invention. FIG. 2 is a process flow chart showing a surface treatment process in the present invention. FIG. 3 is a graph showing a comparison between the present invention and the prior art with respect to the bonding strength between an upper plate and magnet kept under several environment. FIG. 4 is a graph showing a comparison between the present invention and prior art with respect to bonding strength under each heat test condition.

The difference between the present preferred embodiment and the prior art is relating to the surface treatment of the metallic members. The portion relating to the surface treatment of the present invention will be described in the following.

In FIG. 1, a surface of upper plate 1a, which is made of a base member 1h made of iron or its alloy and having zinc plated surface 1e formed thereon, is further covered with surface treatment layer 1f and also protective layer 1g.

The surface treatment process will be described in the following with reference to FIG. 2.

In the process shown in FIG. 2, the present invention is identical with prior art up to washing process No. 10 after zinc plating.

In the present invention, instead of conventional chromate treatment, surface treatment is performed on the zinc plated surface 1e including coating process (surface treatment) 11′ of inorganic surface treatment layer 1f mainly consisting of colloidal silica, drying process 12′, forming process (finishing) 13′ of protective layer 1g, and drying process 14′.

The materials used for the surface treatment and its treating method in the present invention will be described in the following.

The material used in the surface treatment process 11′ is a water based dispersion containing colloidal silica as main component and further containing colloidal oxides such as alumina and the like. Different kinds of metallic components such as titanium and cobalt can be further added to the dispersion to improve the corrosion resistance of the coating. These metals turn into colloidal particles of metal oxide or hydroxide when added into the water based dispersion in the form of metal alkoxide, and react with hydroxyl group of silica surface in the dispersion or they are absorbed to the silica surface. Also, when these metals are added in a state of metallic salt or metallic soap, they finally form metal oxide by a heat treatment after the surface treatment, hereby forming a coating layer having excellent adhesion to the base material. As a titanium source, titanium tetrachloride reacts with moisture in air and produces titanium dioxide, therefore, it is desirable to use stable titanium sulfate or titanium alkoxide. Further, since sulfate ion is hard to evaporate at low temperatures, it is desirable to make colloidal silica and titanium alkoxide react with each other in the dispersion beforehand.

As colloidal silica, for example, a product named SNOWTEX supplied by Nissan Chemical Co., Ltd. can be used. Such colloidal silica is supplied in water dispersion type and alcohol dispersion type, and it is desirable to use water dispersion type colloidal silica, taking into account the cost and stability of the colloid. Further, in order to improve the characteristic of dried coating layer, a product with alumina added into the colloidal silica is also available.

The silica dispersion is usually stabilized under an acidic state using hydrochloric acid, but, the hydrochloric acid evaporates during the washing and the drying process after the surface treatment and does not affect the metal surface treated.

It is also possible to improve the characteristic of the coating layer by adding ethyl silicate to the colloidal dispersion or by adding reactive silane compound such as trimethoxyl methyl silane to react with hydroxyl group of silica surface. Adding ethyl silicate increases a toughness of the coating layer, and surface treatment layer 1f being free from damage even when an object to be surface treated is subjected to stresses such as bending may be obtained. Also, the addition and reaction of reactive silane compound can increase a solid content in the treating dispersion and improves the toughness of the coating layer.

As a surface treatment method, the object to be treated is immersed into the treating dispersion or the treating dispersion is sprayed to the object to be treated, followed by drying (heat treatment). In the drying process, if an excess amount of the treating dispersion sticks to the object to be treated, it may cause whitening of the surface of surface treatment layer 1f. It must be noted that such whitening makes it difficult to obtain sufficient corrosion resistance. A rotational treatment method using a centrifugal force to remove excessive dispersion is appropriate for mass-production.

The drying temperature is preferable to be in a range between 80° C. and 250° C. If the drying temperature is too low, sufficient coating characteristics is not be obtained, and if the temperature is higher, long time for cooling is needed, resulting in lower productivity. An excellent corrosion resistance of surface treatment layer 1f is obtained when the drying temperature is high. Also, instead of the high-temperature treatment, nitric acid may be added to the treating dispersion to perform oxidation reaction.

Forming of the surface treatment layer 1f is followed by finishing treatment. The composition of the treatment liquid used for the finishing is basically the same as that of the surface treating dispersion. It is also preferable to add nitric acid to the treating dispersion and to immediately process finishing treatment without drying before the finishing treatment.

In the present preferred embodiment, a product named METAS ESC supplied by Yuken Industrial Co. Ltd. is used for the surface treatment, and water-soluble type or water-dispersion type METAS 99 is used as the finishing agent.

FIG. 3 and FIG. 4 show the results of the comparison between the present invention and the prior art with respect to the bonding strength (with bonding area set to about 30 cm²) between the magnet 1b and the upper plate 1a. In FIG. 3,

(1) heat resistance is represented by a bonding strength after 240 hour keeping in an atmosphere of 100° C.;

(2) cold resistance is represented by a bonding strength after 240 hour keeping in an atmosphere of −40° C. for;

(3) humidity resistance is represented by a bonding strength after 500 hour keeping in an atmosphere of 55° C., 95%; and

(4) heat shock test is represented by a bonding strength after 1000 cycles of heat shock, each cycle includes keeping one hour in an atmosphere of 85° C. immediately after one hour keeping in an atmosphere of −40° C.

And, FIG. 4 shows changes of the bonding strength after heating for heat resistance test with regard to the upper plate 1a surface-treated by the method of the present preferred embodiment and the method of the prior art, the upper plate 1a being bonded to the magnet 1b. The heating conditions are one hour keeping in an atmosphere of 150° C., one hour keeping in an atmosphere of 200° C., and one hour keeping in an atmosphere of 250° C., respectively. In FIG. 4, graph “a” shows a bonding strength of the sample of the present preferred embodiment, and graph “b” shows a bonding strength of the sample of the prior art.

As is apparent from the results in FIG. 3 and FIG. 4, it has been confirmed that the bonding strength obtained in the samples of the present preferred embodiment is superior to that of the prior art under all test conditions, except that the bonding strength obtained in the humidity test is equivalent to that of the prior art.

Further, a salt solution spray test was performed on an upper plate surface treated by the method of the present preferred embodiment. The test conditions are that the surfaces are visually observed after 3 or 6 cycles of the salt solution spray test, in each cycle a 5% NaCl solution is sprayed for 8 hours in an atmosphere of 35° C. followed by a 16-hour drying process. In the salt solution spray test, there was no difference between the prior art and the present preferred embodiment after 3 cycles of the test, but corrosion was observed in the sample of the prior art after 6 cycles, which was judged to be defective. On the other hand, no corrosion was observed in the sample of the present preferred embodiment.

Also, in a hydrogen sulfide test (visual observation of the surface after 1000 hour keeping in an atmosphere of H₂S at a concentration of 5 ppm), no corrosion was observed in the sample of the present preferred embodiment, but corrosion was observed in the sample of the prior art after 500 hour keeping and was judged to be defective. The surface treatment of a plate for magnetic circuit of electro-acoustic transducer has been described above. The present invention is not limited only to the embodiment described above, but it may naturally be applied to the bonding of a similarly zinc plated frame and upper plate. Further, the present invention is also effective for the treatment of other component members for electro-acoustic transducers such as a neodynium-based magnet.

As described above, surface-treated members in the present preferred embodiment has sufficient corrosion resistance, high reliability, and excellent quality with respect to heat resistance. Thus, the present invention can provide members for electric and electronic equipment, members for electro-acoustic transducers and their manufacturing method, the members having high reliability and excellent heat resistance.

In the present preferred embodiment, water-soluble type or water-dispersion type resin of colloidal silica was used as a finishing agent, but it is also possible to use water-soluble type or water-dispersion type resin based on acrylic resin, melamine resin or silicone resin.

Also, in the preferred embodiment, the present invention is described that the members for eletro-acoustic transducers have excellent characteristics, taking a loudspeaker as an example, and their manufacturing method. However, it should be noted that zinc plating or zinc alloy plating is not limited to the use for electro-acoustic transducers such as loudspeakers.

That is, the present invention can be widely used as members for electronic components and members for electronic and electric equipment to be used in places where high bonding strength is required or high reliability is required in terms of heat resistance and environmental resistance. For example, the present invention can be effectively used for cases of electronic equipment, members for various kinds of mechanical components and the like.

### INDUSTRIAL APPLICABILITY

As described above, the present invention is intended to form a coating layer having excellent corrosion resistance on the surface of a member made of iron based material. The coating layer thus formed improves the heat resistance of the member. Therefore, it is particularly applicable to a member for electro-acoustic transducers with excellent input resistance or electro-acoustic transducers for vehicles which are required to have high corrosion resistance. That is, the treatment of the present invention improves the bonding strength between a magnet and a plate of a magnetic circuit, and a small-sized and light-weight electro-acoustic transducer having excellent quality is obtained.

### REFERENCE NUMERALS

1 Magnetic circuit

1a Upper plate

1b Magnet

1c Lower plate

1d Magnetic gap

1e Zinc plated surface

1f Surface treatment layer

1g Protective layer

1h Base member

2 Frame

3 Diaphragm

4 Voice coil

5 Damper

1. A member for electric equipment having:
a surface treatment layer comprising colloidal silica as a main component and formed on a surface of a metallic component having a zinc or zinc alloy layer formed on a surface thereof; and
a protective layer formed on a surface of said surface treatment layer.

2. The member for electric equipment of claim 1, wherein said surface treatment layer further includes at least one of aluminum, titanium, and cobalt as a metallic component.

3. The member for electric equipment of claim 1, wherein said protective layer is at least one selected from the group consisting of a layer mainly consisting of colloidal silica, an acrylic resin layer, a melamine resin layer, and a silicone resin layer.

4. The member for electric equipment of claim 3, wherein said protective layer mainly consisting of colloidal silica further contains at least one of aluminum, titanium, and cobalt as a metallic component.

5. The member for electric equipment of any one of claim 1 through claim 4, wherein said member for electric equipment is a member for electric equipment of an electro-acoustic transducer.

6. The member for electric equipment of claim 5, wherein said member for electric equipment is at least one of a loudspeaker frame, a plate for a magnetic circuit, and a magnet of an electro-acoustic transducer.

7. The member for electric equipment of claim 5, wherein said member for electric equipment is a member for electric equipment of an electro-acoustic transducer for automotive vehicles.

8. A surface treatment method of member for electric equipment, comprising the steps of:
zinc plaing a member made of a iron based material;
forming a surface treatment layer mainly consisting of colloidal silica on a zinc plated surface; and
forming a protective layer on a surface of said surface treatment layer.

9. The surface treatment method of member for electric equipment of claim 8, wherein said surface treatment layer further includes at least one of aluminum, titanium, and cobalt as a metallic component.

10. The surface treatment method of member for electric equipment of claim 8, wherein said protective layer is at least one selected from a layer mainly consisting of colloidal silica, an acrylic resin layer, a melamine resin layer, and a silicone resin layer.

11. The surface treatment method of member for electric equipment of claim 10, wherein said protective layer mainly consisting of colloidal silica further includes at least one of aluminum, titanium, and cobalt as a metallic component.

12. The surface treatment method of member for electric equipment of any one of claim 8 through claim 11, wherein said member for electric equipment is a member for electric equipment of an electro-acoustic transducer.

13. The surface treatment method of member for electric equipment of claim 12, wherein said member for electric equipment is at least one of a loudspeaker frame, a plate for magnetic circuit, and magnet.

14. The surface treatment method for member for electric equipment of claim 12, wherein said member for electric equipment is a member for electric equipment of an electro-acoustic transducer for automotive vehicles.

15. A method of manufacturing electro-acoustic transducer, comprising the steps of:
forming a surface treatment layer mainly consisting of colloidal silica on a surface of a plate for magnetic circuit and a surface of a frame, the surfaces of the plate and the frame being zinc plated;
forming protective layers on surfaces of said surface treatment layers; and
bonding the plate and the frame formed with said protective layers to a magnet.

16. The method of manufacturing eletro-acoustic transducer of claim 15, wherein said surface treatment layer further includes at least one of aluminum, titanium, and cobalt as a metallic component.

17. The method of manufacturing electro-acoustic transducer of claim 15, wherein said protective layer is at least one selected from a layer mainly consisting of colloidal silica, an acrylic resin layer, a melamine resin layer, and a silicone resin layer.

18. The method of manufacturing electro-acoustic transducer of claim 15, wherein said protective layer mainly consisting of colloidal silica further includs at least one of aluminum, titanium, and cobalt as a metallic component.
